(19) United States
(12) Patent Application Publication
(10) Pub. No.: US 2025/0214061 A1
(43) Pub. Date: Jul. 3, 2025

(54) MICROWAVE ACTIVATION OF MINERALS FOR CARBON SEQUESTRATION

(71) Applicant: THE UNIVERSITY OF BRITISH COLUMBIA, Vancouver (CA)

(72) Inventors: Peter P. SCHEUERMANN, Vancouver (CA); Greg M. DIPPLE, Vancouver (CA); Seyed Ali GHOREISHI MADISEH, Vancouver (CA)

(21) Appl. No.: 18/850,015

(22) PCT Filed: May 16, 2023
(86) PCT No.: PCT/CA2023/050673

§ 371 Date: Sep. 23, 2024

Related U.S. Application Data
(60) Provisional application No. 63/343,032, filed on May 17, 2022.

(51) Int. Cl. B01J 20/30; B01J 20/10; C01F 5/00; C01G 49/00

(52) U.S. Cl. CPC B01J 20/30; B01J 20/10; C01F 5/00; C01G 49/009

(57) ABSTRACT

A method for activating minerals using microwaves to enhance the reactivity of the minerals to carbon dioxide.

### CROSS-REFERENCE TO RELATED APPLICATIONS

This application claims priority to, and for the purposes of the United States of America the benefit of, provisional patent application No. 63/343,032 filed 17 May 2022 entitled Microwave Activation of Minerals for Carbon Sequestration, the entirety of which is incorporated by reference herein for all purposes.

### TECHNICAL FIELD

Some embodiments relate to the activation of minerals to enhance sequestration of carbon dioxide by such minerals. Some embodiments relate to the activation of minerals using microwaves to enhance sequestration of carbon dioxide by such minerals.

### BACKGROUND

The mineral serpentine (Mg₃Si₂O₅(OH)₄) is a prime candidate for carbon mineralization due to its high capacity to sequester CO₂ and its abundance, both naturally and as a waste product of the mining industry. If completely carbonated, one tonne of serpentine has the potential to sequester 0.47 tonne CO₂ as benign and stable magnesium carbonate minerals. Today, the mining industry produces approximately 169 Mt/yr of serpentine bearing tailings, with production forecast to increase to 3.5 Gt/yr by 2100. It is estimated that there are in excess of 4-100 Gt of historical serpentine-rich mine tailings globally (Franks et al., 2021). Large nickel mines, such as Mt. Keith in Western Australia, have the potential to sequester up to 4 Mt CO₂ each year, or approximately ten times the mine's annual CO₂ emissions. Nickel is a crucial battery metal, and therefore carbon mineralization in tailings of active nickel mines will significantly decarbonize the electric vehicle supply chain.

However, there are problems in achieving the complete potential of serpentine as a carbon removal feedstock because, no matter how finely ground, it reacts slowly, meaning only ˜1% of the overall mineralization potential is attainable at Earth surface conditions and at timescales relevant to combat climate change (years). A pre-treatment is needed to enhance the rate of dissolution and activate a larger portion of the mineralization potential. Thermal pre-treatment techniques have received significant research interest due to their ability to increase the reactivity of serpentine to CO₂. Thermal treatments require heating serpentine to 600-750° C. for up to three hours. At these temperatures, the hydroxyl groups (OH) within the mineral structure are released, resulting in an amorphous solid that is extremely reactive to CO₂. However, heating to such high temperatures requires significant amounts of energy, leading to uneconomically high operating costs. In addition, fossil fuels are the primary source of heat for thermal treatment resulting in significant carbon emissions, thereby decreasing the overall efficiency of the carbon removal process.

There remains a need for more efficient methods for sequestering carbon dioxide in an inert form.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a method of enhancing the reactivity of a sample of a mineral to carbon dioxide comprising exposing the sample to microwave treatment for a treatment period to produce a microwave-activated mineral. One aspect provides a method of reducing a temperature required to dehydroxylate magnesium-iron phyllosilicate minerals as compared to thermal treatment at the same heating rate and sample particle size comprising exposing a sample of the mineral to microwave treatment for a treatment period to produce a microwave-activated mineral.

In some aspects, the applied power density of the microwaves is greater than about 10⁶ W/m³. In some aspects, the applied power density of the microwaves is between about 10⁶ W/m³ to about 10⁸ W/m³. In some aspects, the applied power density of the microwaves is greater than about 10⁸ W/m³. In some aspects, the treatment period is between 0.1 seconds/kg of sample present and 20 minutes/kg of sample present. In some aspects, the sample is powdered rock, rock granules or rock fragments. In some aspects, the powdered rock has an average particle diameter of between about 10 microns and about 250 microns, the rock granules have an average particle diameter of between about 250 microns and about 1 mm, and the rock fragments have an average particle diameter of between about 1 cm and about 25 cm.

In some aspects, the mineral comprises a mineral in the serpentine subgroup. In some aspects, the mineral is serpentine. In some aspects, less than 20% of the serpentine is converted to olivine during the microwave treatment. In some aspects, a bulk temperature of the sample does not exceed about 650° C., about 600° C., about 550° C. or about 515° C. during the microwave treatment. In some aspects, the sample is subjected to thermomechanical activation at a temperature of between about 100° C. and about 500° C. prior to microwave treatment.

In one specific aspect, the total energy absorbed by the sample from the microwaves is less than or equal to about 97 kWh per tonne of sample; the microwave-activated mineral has at least about 0.3 weight % loss, due to dehydroxylation of serpentine, relative to a starting weight of the sample; and/or a bulk temperature of the sample does not exceed about 515° C. during the microwave treatment. In another specific aspect, the total energy absorbed by the sample from the microwaves is less than or equal to about 225 kWh per tonne of sample; the microwave-activated mineral has at least about 4.75 weight % loss, due to dehydroxylation of serpentine, relative to a starting weight of the sample; and/or a bulk temperature of the sample does not exceed about 650° C. during the microwave treatment.

In one aspect, the method further comprises exposing the microwave-activated mineral to carbon dioxide, optionally to atmospheric air at ambient temperature and ambient pressure.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1A shows an example embodiment of a process for treating a mineral to enhance reactivity of the mineral to carbon dioxide.

FIG. 1B shows an example embodiment of a process for treating a mineral and sequestering carbon in the mineral.

FIG. 1C shows a second example embodiment of a process for treating a mineral and sequestering carbon in the mineral.

FIG. 2 shows the apparent heat capacity for ATL, TUL and AMP rock types.

FIG. 3, being comprised of FIGS. 3A and 3B, shows thermogravimetric analysis (TGA, weight loss versus temperature) for unreacted TUL samples.

FIG. 4A shows infrared images and numerical simulation of the ATL sample post microwave exposure. FIG. 4B shows infrared images and numerical simulation of the TUL sample post microwave exposure. FIGS. 4C, 4D, 4E, and 4F show the infrared images of TUL samples after microwave exposure. FIGS. 4G, and 4H show the infrared images of AMP samples after microwave exposure.

FIG. 5A(i) shows TGA (weight loss versus temperature) and FIG. 5A(ii) shows the derivative of weight loss versus temperature (∂wt %/∂T) for samples for an exemplary sample of mineral before and after exposure to microwaves. FIGS. 5B(i) and (ii), 5C(i) and (ii), and 5D(i) and (ii), 5E(i) and (ii), 5F(i) and (ii), and 5G(i) and (ii) show parallel results for other exemplary sample of mineral before and after exposure to microwaves.

FIG. 6 shows the rate of carbon dioxide capture from air in unreacted and microwave activated TUL samples.

FIG. 7 shows the reactive magnesium content (wt %) as a function of time for untreated and microwave activated TUL samples.

FIG. 8A(i) shows TGA for samples before and after conventional thermal treatment to 600° C. FIG. 8A(ii) shows the derivative of weight loss versus temperature. FIGS. 8B(i) and (ii), 8C(i) and (ii), 8D(i) and (ii) show parallel results for conventional thermal treatment at 650° C., 700° C. and 750° C., respectively.

FIGS. 9A and 9B show the comparison between heat flow and dielectric properties for TUL (FIG. 9A) and AMP (FIG. 9B) rock types.

FIG. 10 shows the relationship between the temperature of maximum reaction and extent of serpentine dehydroxylation.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

The inventors have now determined that microwave treatment of serpentine can be used to dehydroxylate the serpentine to increase its reactivity with carbon dioxide, without the need to convert the serpentine to olivine. Such microwave treatment may be accomplished using less energy than thermal dehydroxylation processes. The microwaves may be produced via electricity, rather than requiring a source of thermal energy.

As used herein, the term “microwave” encompasses electromagnetic radiation having a frequency of between 300 MHz and 300 GHz, corresponding to a wavelength of between 1 m and 1 mm.

The microwaves used can be generated by any suitable source of microwaves, whether currently known or developed in future, including any type of microwave generator including solid state microwave generators, or the like.

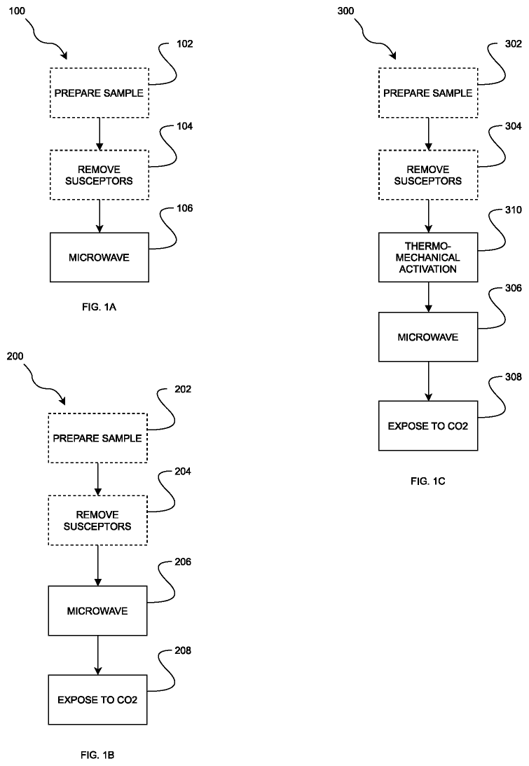

With reference to FIG. 1A, an example embodiment of a method 100 for treating a mineral to enhance the reactivity of the mineral to carbon dioxide is illustrated.

In some embodiments, the minerals are hydrous magnesium-iron phyllosilicates, including the serpentine subgroup, antigorite, lizardite and chrysotile. In some embodiments, the minerals include talc and/or the chlorite subgroup, e.g. chlinochore, chamosite, odinite and the like. In some embodiments, the minerals are serpentine. In some embodiments, the sample that is subjected to microwave treatment does not contain magnetite.

At step 102, the mineral is optionally prepared in any desired manner. For example, in some embodiments, the mineral is dried, so that an excess of moisture that would absorb microwave radiation is removed. Drying can be accomplished in any suitable manner, for example storing the mineral in a dry environment at ambient temperature and allowing moisture to evaporate naturally, gently heating the mineral, using a microwave drying process, or the like. In some embodiments, the sample is ground or otherwise size-reduced at step 102. In some embodiments, the sample is ground to have an average particle size in the range of about tens of microns to coherent slabs, including any value therebetween.

In some embodiments, the naturally occurring minerals that act as electromagnetic susceptors (e.g., magnetite, pyrrhotite, pyrite) are removed from the sample at step 104 before application of microwaves.

At step 106, the mineral is exposed to microwave radiation (referred to herein as microwaves) for a treatment period to dehydroxylate the mineral.

The microwaves used in various embodiments may have any desired frequency. In some embodiments, the microwaves have a frequency between 300 MHz and 300 GHz, including any value therebetween, e.g. 400, 500, 600, 700, 800, or 900 MHz, or 1, 10, 20, 50, 100, 125, 150, 175, 200, 225, 250 or 275 GHz. In some embodiments, the microwaves used have a frequency of 2.4 GHz. In some embodiments, the microwaves used have a frequency of 915 MHz.

In some embodiments, the power of the microwaves applied at step 106 is between 0.5 and 100 kW, including any value therebetween, e.g. 3, 5, 10, 20, 30, 40, 50, 60, 70, 80, 90, kW. In some specific embodiments, the power of the microwaves applied at step 106 is between about 1 and about 10 kW, or between about 10 and about 100 kW.

In some embodiments, the treatment period during which microwaves are applied is as little as 40 seconds. In some embodiments, the treatment period during which microwaves are applied is between approximately 0.1 second and 3.5 minutes, including any value therebetween, e.g. 2, 3, 5, 10, 15, 20, 25, 30, 35, 40, 45, 50 or 55 seconds, or 1, 2, or 3 minutes. In some embodiments, the treatment period during which microwaves are applied is between approximately 3.5 and 15 minutes, including any value therebetween, e.g. 2, 3, 5, 10, 15, minutes. In some embodiments, the treatment period during which microwaves are applied is between approximately 0.1 seconds and 15 minutes, including any value therebetween. In other embodiments, different treatment periods could be used if other parameters such as the power of the applied microwaves are adjusted, for example treatment periods longer than 15 minutes. In some embodiments, the treatment period is between 15 minutes and 25 minutes, including any value therebetween, e.g. 16, 17, 18, 19, 20, 21, 22, 23 or 24 minutes.

In some embodiments, the treatment period during which microwaves are applied is determined based on the amount of sample present. For example, in some embodiments, the treatment period is between about 0.1 seconds/kg of mineral present to about 20 minutes/kg of mineral present, including any value therebetween, e.g. 0.2, 0.4, 0.6, 0.8, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, 10, 11, 12, 13, 14, 15, 16, 17, 18 or 19 minutes/kg of mineral present.

In some embodiments, the total energy absorbed by the sample during the treatment period is less than or equal to about 225 kWh/tonne sample, including e.g. less than or equal to about 220, 215, 210, 205, 200, 195, 190, 185, 180, 175, 170, 165, 160, 155, 150, 145, 140, 135, 130, 125, 120, 115, 110, 105 100, 95, 90, 85, 80, 75, 70, 65, 60, 55, 50, 45, 40, 35, 30 or 25 kWh/tonne sample). In some embodiments, the total energy absorbed by the sample during the treatment period is between about 25 and about 225 kWh/tonne sample. In one specific embodiment, the total energy absorbed by the sample during the treatment period is less than about 97 kWh/tonne.

In some embodiments, the sample loses about or greater than about 0.3 weight % due to serpentine dehydroxylation during microwave treatment, including greater than about 0.4, 0.5, 0.6, 0.7, 0.8, 0.9, 1.0, 1.25, 1.50, 1.75, 2.0, 2.25, 2.5, 2.75, 3.0, 3.25, 3.5, 3.75, 4.0, 4.25, 4.5, 4.75 or more weight % due to serpentine dehydroxylation. In one embodiment, the sample loses about or greater than about 4.75 weight percent due to serpentine dehydroxylation, including e.g. greater than about 5.0, 5.25, 5.5, 5.75 or 6.0 weight percent. In some embodiments, the sample loses between about 4.75 and about 6.0 weight percent due to dehydroxylation. In some embodiments, the total energy absorbed by the sample is less than or equal to about 225 kWh/tonne sample, and the sample after treatment has a mass loss, due to serpentine dehydroxylation, that is at least about 4.75 wt % or more relative to the sample before treatment, and the bulk temperature of the sample during microwave treatment does not exceed about 650° C. during the microwave treatment. In one specific embodiment, the total energy absorbed by the sample from the microwaves is less than or equal to about 97 kWh per tonne of sample, the microwave-activated mineral has at least about 0.3 weight % loss due to dehydroxylation of serpentine relative to the starting weight of the sample, and a bulk temperature of the sample does not exceed about 515° C. during microwave treatment. In some embodiments, the sample is powders of a magnesium-iron phyllosilicate mineral having a diameter of less than 250 μm and the temperature required to dehydroxylate the powder is less than 515° C.

In some embodiments, the total applied energy is less than or equal to about 300 kWh/tonne sample, including e.g. less than or equal to about 250, 200, 150, 100 or 50 kWh/tonne sample. In some embodiments, the total applied energy is between about 50 and about 300 kWh/tonne sample.

In some embodiments, the applied power density of the microwaves is greater than about 10⁶ W/m³ or greater than 10⁷ W/m³, including e.g. greater than about 10⁸ or greater than about 10⁹ W/m³. In some embodiments, the applied power density of the microwaves is between about 10⁷ W/m³ and about 10⁹ W/m³. In some embodiments, the applied power density of the microwaves is between about 10⁶ W/m³ and about 10⁸ W/m³, including any value therebetween, e.g. about 10⁷ W/m³.

In some embodiments, a heating rate of the sample during the microwave treatment is at least about 100° C./min, including e.g. at least about 105, 110, 115, 120, 125, 130, 135, 140, 145 or 150° C./min. In some embodiments, a heating rate of the sample during the microwave treatment is between about 100° C./min and about 150° C./min.

In some embodiments, the sample is powdered rock, e.g. having an average particle diameter of less than about 250 μm, including less than 200, 150, 100, 50, or 10 μm. In some embodiments, the powdered rock has an average particle diameter of between about 10 μm and about 250 μm, including any value therebetween, e.g. 20, 30, 40, 50, 60, 70, 80, 90, 100, 110, 120, 130, 140, 150, 160, 170, 180, 190, 200, 210, 220, 230 or 240 μm. In some embodiments, the sample is rock granules, e.g., having an average particle size of between about 0.25 mm and about 1 mm, including e.g. about 0.3, 0.4, 0.5, 0.6, 0.7, 0.8 or 0.9 mm. In some embodiments, the sample is rock fragments, e.g. having an average diameter of greater than about 1 mm, including greater than about 2, 3, 4, 5, 10, 15, 20 or 25 mm, and also including between about 1 cm and 25 cm, including e.g. 2, 3, 4, 5, 10, 15 or 20 cm. In some embodiments, the sample has an average particle diameter of between about 0.001 and about 25 cm, including any value therebetween e.g. 0.002, 0.005, 0.01, 0.02, 0.03, 0.04, 0.05, 0.1, 0.2, 0.3, 0.4, 0.5, 0.6, 0.7, 0.8, 0.9, 1.0, 1.5, 2.0, 2.5, 3.0, 4.0, 5.0, 6.0, 7.0, 8.0, 9.0, 10.0, 12.0, 14.0, 16.0, 18.0, 20.0, 22.0 or 24.0 cm.

In some embodiments, the bulk temperature of the sample during microwave treatment is less than about 650° C., including e.g. less than about 600, 550, 500, 450, 400 350, 300, 250, or 200° C. In some embodiments, the bulk temperature of the sample during microwave treatment is between about 250° C. and about 650° C., including any range therebetween e.g. 300, 350, 400, 450, 450, 500, 550, or 600° C. In one specific embodiment, the bulk temperature of the sample during microwave treatment is less than about 515° C.

The inventors have determined that the amount of microwave energy applied to dehydroxylate serpentine as an exemplary mineral using method 100 is less than the amount of thermal energy that would be required to dehydroxylate the serpentine. In other words, dehydroxylation can be carried out using microwaves at a temperature that is lower than a temperature that would be required to carry out thermal dehydroxylation of the serpentine, controlling for equivalent process parameters of heating rate and mineral particle size.

The inventors have also determined that serpentine can be dehydroxylated using method 100 without converting the serpentine to olivine, based on thermogravimetric analysis of microwave activated samples. In some embodiments, the amount of serpentine that is converted to olivine during the microwave treatment is less than about 10%, less than about 20% or less than about 30%.

With reference to FIG. 1B, an exemplary embodiment of a method 200 for treating a mineral and sequestering carbon in the mineral is illustrated. Steps of method 200 that correspond to steps of method 100, i.e. sample preparation step 202, removal of susceptors at step 204 and microwave step 206, have been illustrated with reference numerals incremented by 100 and are not further described again.

In method 200, after microwave step 206 has been completed, the microwaved mineral is exposed to carbon dioxide at step 208 to sequester carbon dioxide as inert compounds in the mineral. The microwaved mineral can be exposed to carbon dioxide in any suitable manner, for example by exposure to atmospheric air at ambient temperature, by exposure to a process stream containing or consisting of carbon dioxide, or the like. In some embodiments in which the microwaved material is crushed material having a relatively large particle size and/or slabs, after microwave step 206 has been completed, the microwaved material is size-reduced to a powder, for example having an average particle size of 500 μm or less, prior to step 208. In some embodiments, after microwave step 206 has been completed, the microwaved material is size-reduced to powdered rock, rock granules and/or rock fragments having sizes as previously described herein.

In some embodiments, subsequent to microwave treatment, the mineral can absorb carbon dioxide at step 208 at a rate of at least about 2 kg CO₂/m² year, including e.g. at least about, 4, 6, 8, 10, 12, 14, 16, 18 or 20 kg CO₂/m² year, including e.g. between about 2 kg CO₂/m² year and about 20 kg CO₂/m² year.

With reference to FIG. 1C, an exemplary embodiment of a method 300 for treating a mineral and sequestering carbon in the mineral is illustrated. Steps of method 300 that correspond to steps of method 200, i.e. sample preparation step 302, removal of susceptors at step 304, microwave step 306, and carbon dioxide sequestration step 308 have been illustrated with reference numerals incremented by 100 and are not further described again.

Method 300 differs from methods 100 or 200 in that, prior to microwave treatment at step 306, the sample is treated at 310 by thermomechanical activation. During thermomechanical activation at step 310, the sample is thermally heated to a moderate temperature, for example, between about 100° C. and about 500° C., including any temperature therebetween, e.g. 125, 150, 175, 200, 225, 250, 275, 300, 325, 350, 375, 400, 425, 450 or 475° C., while being subjected to a grinding treatment. In some embodiments, thermomechanical activation is conducted by grinding for approximately 1 hour (e.g. between 30 minutes and 1.5 hours, including any time period therebetween e.g. 40, 50, 60, 70 or 80 minutes) at 300 RPM in a stirred mill at the moderate temperature (see e.g. McKelvey et al., 2005). Without being bound by theory, it is believed that adding a step of thermomechanical activation prior to subjecting the sample to microwave treatment results in a treated mineral that is more reactive with carbon dioxide than material subjected solely to thermomechanical activation, and further requires less energy to achieve an equivalent level of carbon sequestration as could be achieved by thermomechanical activation followed by thermal treatment of the sample.

### EXAMPLES

Certain embodiments are further described with reference to the following examples, which are intended to be illustrative and not limiting in nature.

### Example 1.0—Materials and Methods

Three different serpentinites were used in this study, TUL, ATL and AMP. The samples (several kilograms of each) were collected from known ultramafic sequences in Western Canada and the Midwestern United States.

### 1.1 X-Ray Diffraction

In order to determine the mineralogy of the two samples, each was analyzed by x-ray diffraction (XRD) using the quantitative Rietveld method.

### 1.2 Thermal Analysis

The untreated samples were analyzed using simultaneous thermal analysis (STA). STA combines thermogravimetric analysis (TGA) and differential scanning calorimetry (DSC) in a single instrument and both data streams are collected simultaneously. Samples (powdered) were analyzed using a Labsys EVO DSC/TGA. All analyses were done under an argon atmosphere (20 mL/min), starting at room temperature and ramping to 900° C. at 10° C./min. Heat flow into an empty crucible was also measured under the same analytical conditions to set the baseline. The baseline heat flow was subtracted from that of the combined crucible and sample to determine the heat flow associated with only the sample.

In another series of tests, microwave-activated samples (powdered) were analyzed using only TGA on a Perkin Elmer TGA 4000. Experiments were carried out in a nitrogen atmosphere (20 mL/min) with a heating regime of 20° C. to 900° C. at 10° C./min.

In another series of tests, untreated samples were analyzed using only TGA on a Perkin Elmer TGA 4000. Experiments were carried out in a nitrogen atmosphere (20 mL/min) with a heating regime of 20° C. to 900° C. at either 10 or 40° C./min. The samples in these experiments were powders or intact rock (˜0.5×0.5×0.5 cm).

### 1.3 Microwave Experiments

Rock samples were placed in the microwave cavity on a ceramic crucible as slabs, crushed or powders. Two different microwave systems were used in this study; the first was a laboratory scale single-mode microwave system (2.45 GHz, 5-15 kW).

The following description relates to experiments performed in system 1: crushed samples had particle size between 0.5-10 cm. The mass of the sample (range of 120-935 g) dictated the duration of microwave exposure needed to meet a pre-determined energy input (kWh/tonne rock). This total amount of microwave energy was generally, but not always, set higher than what is needed for serpentine dehydroxylation, to compensate for losses of energy in the microwave circuit and the reflected power. Microwave generator ramp up time of 1.335 seconds was considered when calculating the duration of the experiment.

Immediately upon completion of the microwave exposure, the sample was removed from the cavity, imaged using a thermal camera device and placed in a calorimeter flask. The elapsed time between the end of the microwave irradiation experiment and insertion of the sample into the calorimeter did not exceed 10 seconds. The thermal camera (Fluke, TiS65) has an error of ±5° C. and an upper limit of 565° C. The calorimeter was custom built and has an error of ±2% (Hassani et al., 2020).

Calorimetric analysis of samples allows for calculation of the sensible heat absorbed by a sample. Assuming no heat transfer to the environment, the heat balance within the calorimeter can be expressed as:

$${Q}_{r} + {Q}_{w} = 0 or {Q}_{r} = - {Q}_{w} \qquad ( 1 )$$

where, Q (joules) is the (sensible) heat within either the rock or water. Q of either phase can be calculated as:

$$Q = m Cp Δ T \qquad ( 2 )$$

where m is the mass (g), Cₚ is the specific heat capacity (J/kgₛₐₘₚₗₑ K) and ΔT (K) is the temperature change. During calorimetry, the temperature change in the water is recorded and the heat released by the rock into the water is calculated as:

$${Q}_{r} ( J ) = - {m}_{w} {C}_{p , w} ( {T}_{f , w} - {T}_{i , w} ) \qquad ( 3 )$$

To express the efficiency of the sample in absorbing the available energy, the parameter Heat Over Microwave Efficiency (HOME) is used (Hassani et al., 2020):

$$HOME ( \% ) = \frac{{Q}_{r}}{{P}_{in} Δ t} \qquad ( 4 )$$

where Pᵢₙ is the total power of the microwave and Δt is the duration of microwave exposure. The product of Pᵢₙ and Δt is the total microwave energy that enters the cavity during an experiment.

The second microwave system is a single mode 100 kW machine operating at a frequency of 915 MHz. In this system, the ceramic dish inside the microwave cavity was attached to a mechanical arm that rotates around the center of the cavity. This microwave system was equipped with an infrared thermal camera (Fluke, Thermoview TV40) that monitored the surface temperature of the material in real time (60 Hz frame rate) up to 1200° C. In addition to surface temperature measurements, the temperature at depth within the material was measured using a thermocouple directly after each exposure to microwaves.

### 1.4 Dielectric Properties

The real (ε′) and imaginary (ε″) permittivities of the materials were measured using the cavity perturbation technique, as described in Hutcheon et al., 1992. This technique measures the bulk permittivities of a material over a range of temperatures by raising the sample temperature in a conventional (i.e. thermal) furnace and then removing the sample and instantaneously measuring the material's dielectric response over the frequency range 397-2986 MHz. This procedure occurs both during heating of the sample to a set temperature and during cooling back to room temperature.

### 1.5 Numerical Simulations

Numerical simulations were performed using the COMSOL Multiphysics software package following the procedures outlined in (Shadi et al., 2022). COMSOL Multiphysics couples electromagnetic and heat transfer phenomena by solving energy conservation and Maxwell's equations (e.g., Shadi et al., 2022). Inputs to the software include sample dimensions, density, thermal conductivity, heat capacity, and dielectric properties. Sample dimensions are easily measured in the laboratory. Density and thermal conductivity are measured using ASTM standards D792 and D5334-08, respectively. Heat capacity was calculated by processing differential scanning calorimetry data, following procedures outlined in (Balucan et al., 2013). Temperature dependent (25 to 850° C.) dielectric properties (real permittivity and imaginary permittivity) were measured using the procedure described in Hutcheon et al. (1992).

### 1.6 CO₂ Reactivity Testing

Both the starting materials and samples exposed to microwaves were tested for CO₂ reactivity in two ways. The first test involves measuring the rate of CO₂ capture from ambient air using dynamic closed chamber analysis. The second determines the amount of fast reacting (‘labile’) Mg available when exposed to water and 10% CO₂, following procedures described in Lu (2020). Reactivity testing was performed on the portions of the treated material that showed the largest degree of dehydroxylation.

### 1.7 Thermal Experiments

A portion of the untreated TUL sample was ground to a powder and exposed to thermal heat in a resistance furnace at temperatures between 600-800° C. for between 40 seconds to 75 minutes. 0.5 grams of powder were added in a thin layer at the base of a crucible.

### Example 2.0—Results

### 2.1 XRD

Quantitative XRD analysis of the starting materials indicates that the ATL, TUL and AMP samples contain in excess of 50 wt % serpentine. XRD analysis of AMP indicates that this rock type does not contain magnetite.

### 2.2 Thermal Analysis—Starting Materials

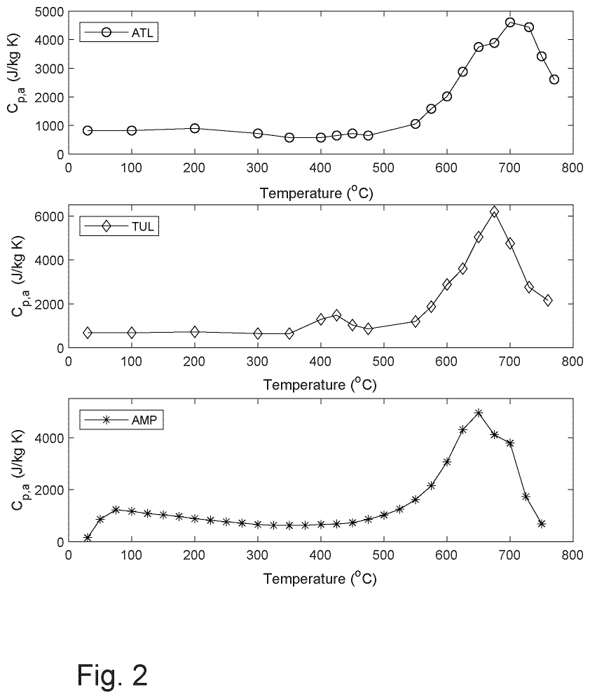

Differential scanning calorimetry (DSC) measures the heat flow (mW) into the sample over a specified temperature range. The time required for the analysis depends on the imposed heating rate, 10° C./min in this study. Apparent heat capacity (Cp,a, J/kgₛₐₘₚₗₑ K) was calculated by taking the derivative of the mW vs time (milliseconds) curve and accounting for the mass (kgs) of the sample at the start of the analysis. For ATL samples, Cp,a starts at 822.9 J/kgₛₐₘₚₗₑ K at 30° C. and increases to a maximum of 4608 J/kgₛₐₘₚₗₑ K at 700° C. For TUL, Cₚ,a is 684 J/kgsamₚie K at 30° C. and reaches a maximum of 6192 J/kgₛₐₘₚₗₑ K at 675° C. For AMP, Cp,a is 150 J/kgₛₐₘₚₗₑ at 30° C. and reaches a maximum of 4949 J/kgₛₐₘₚₗₑ K at 650° C. (FIG. 2).

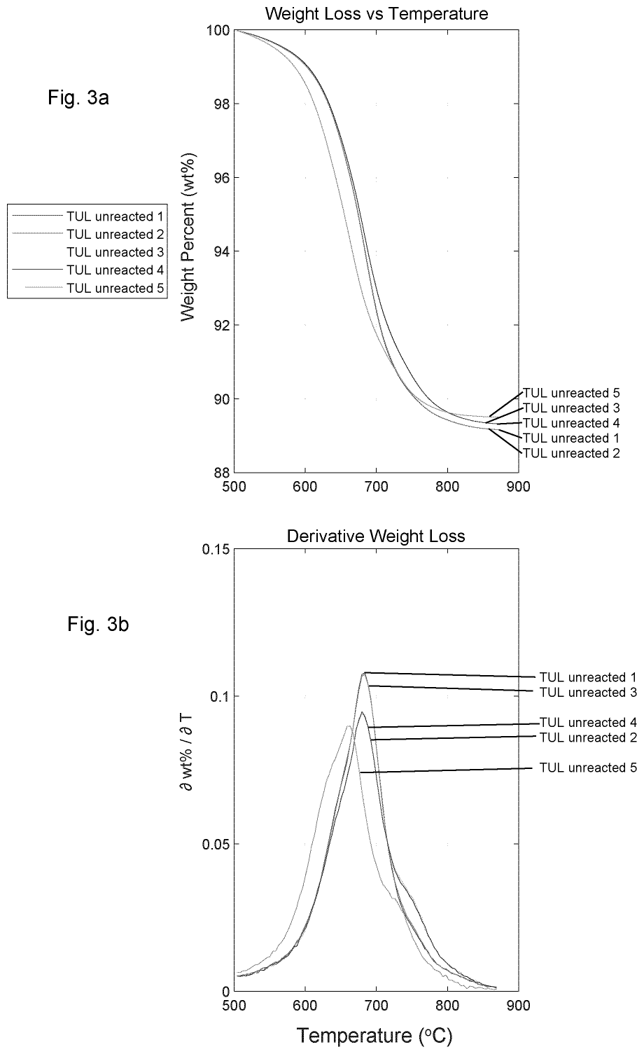

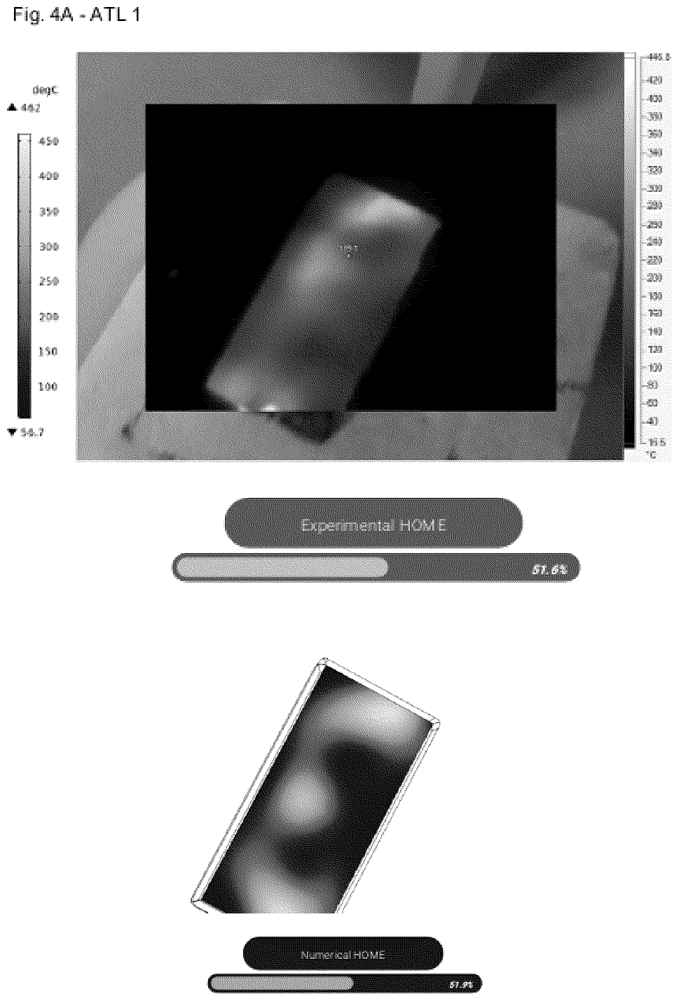

Thermogravimetric analysis of the untreated samples are shown in FIGS. 3A and 3B. Only 500-900° C. is shown since over this temperature range mass loss can be attributed solely to dehydroxylation of serpentine. Results indicate the untreated TUL samples contain an average of 10.7 wt % H₂O (serpentine derived). These values are consistent with those reported in the literature for serpentine (e.g., Zahid, 2020). The untreated TUL samples show maximum rate of water loss (Tₘₐₓ) between 660-683° C., as indicated by the peaks in the plots of ∂wt %/∂T (FIG. 3B).

### 2.3 Microwave and Numerical Experiments—Microwave System 1

Table 1 provides the conditions of the microwave experiments and Table 2 gives the results of calorimetry. Calorimetry indicates that between 22-53.6% of the overall microwave energy that entered the cavity was absorbed in the samples.

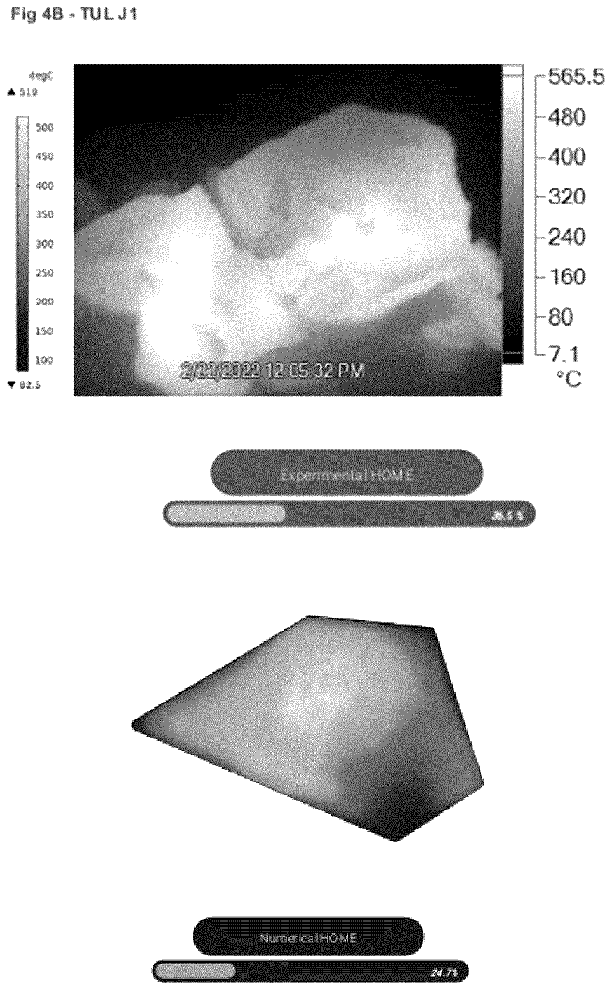

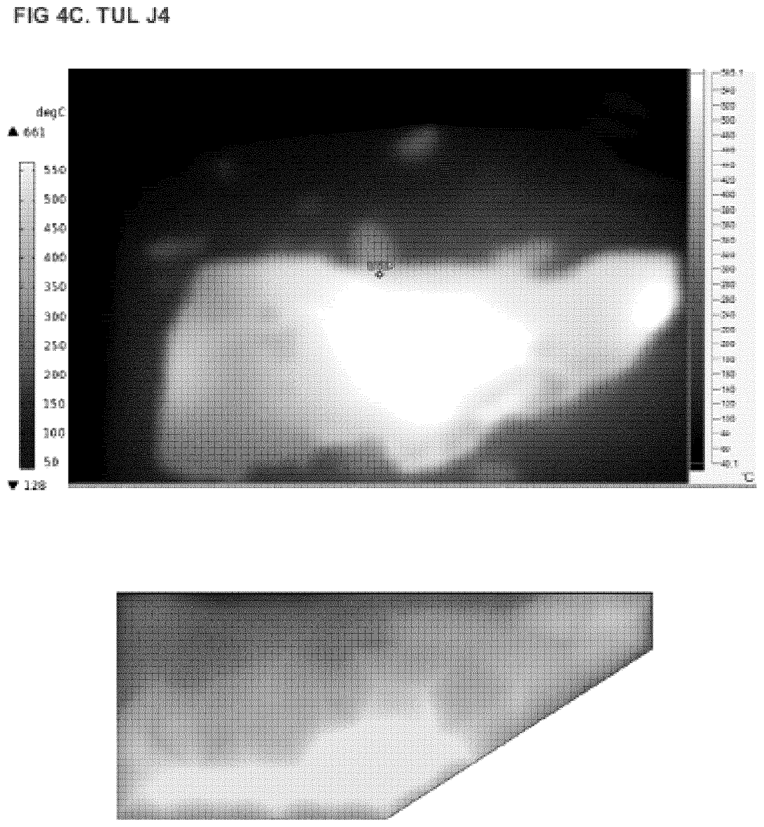

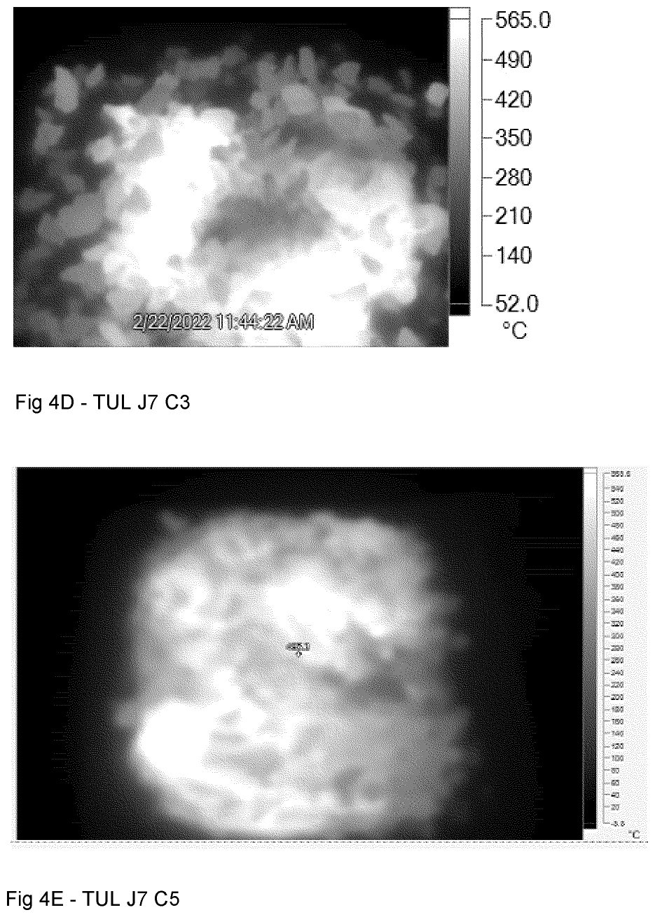

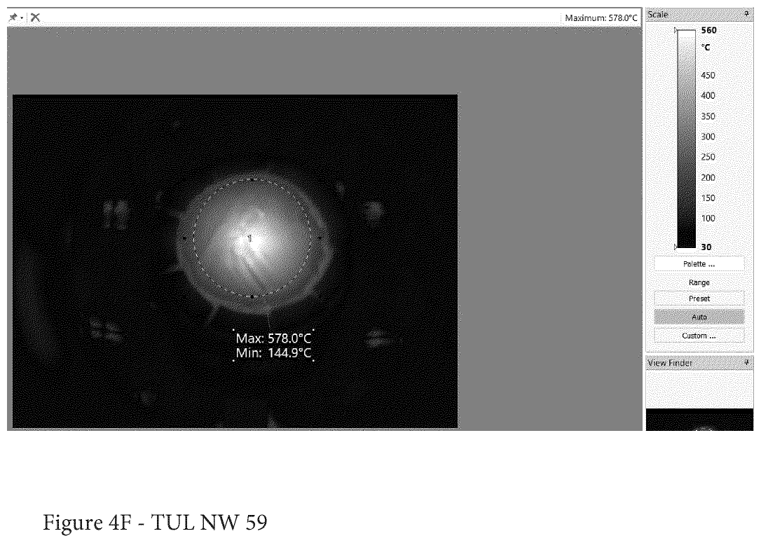

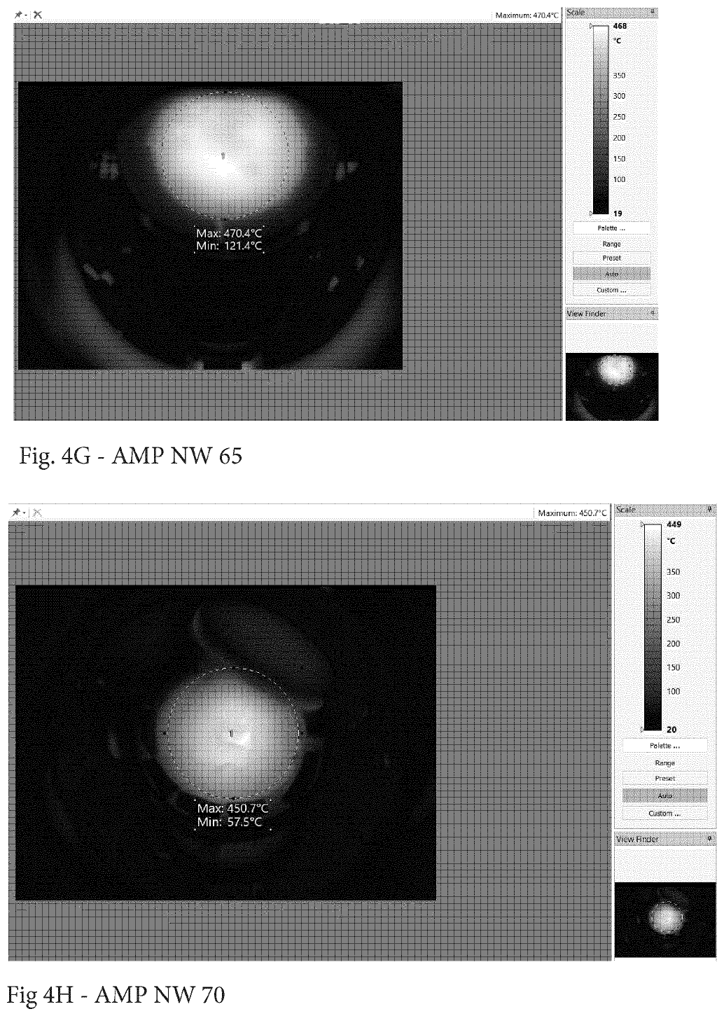

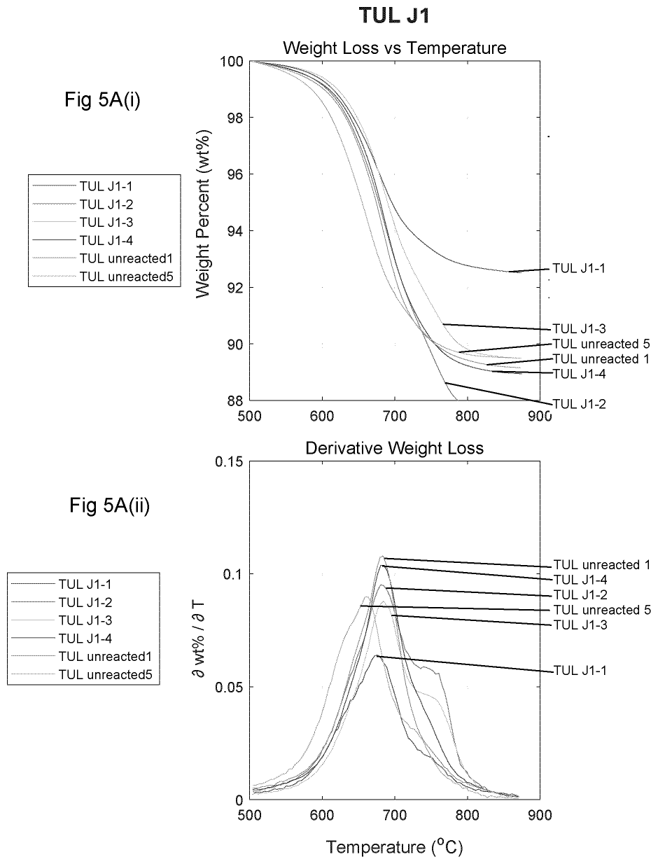

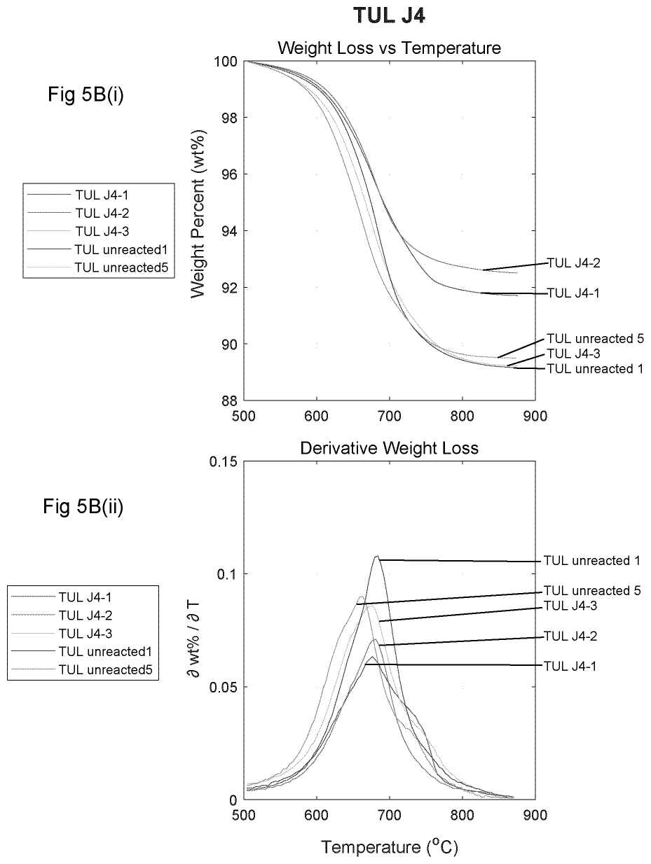

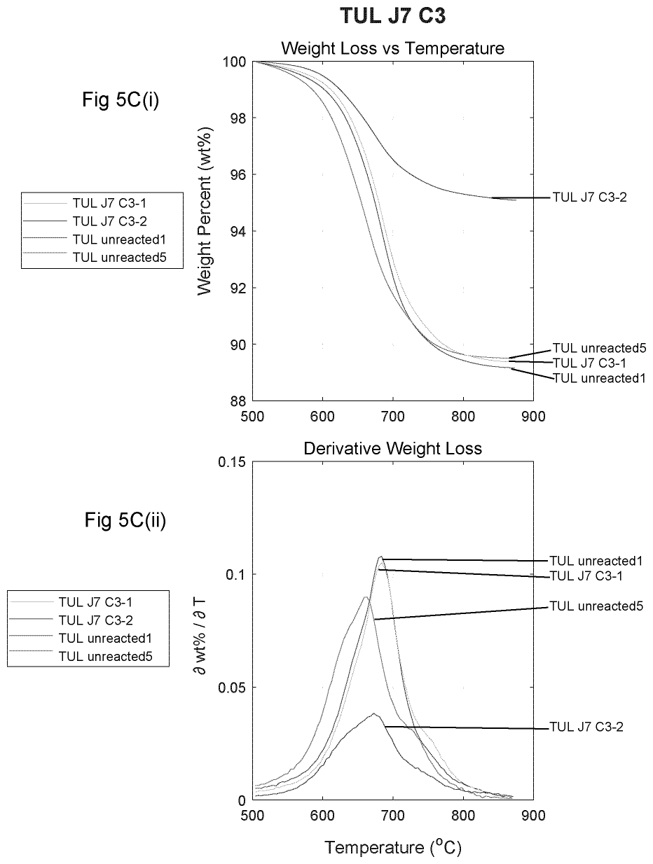

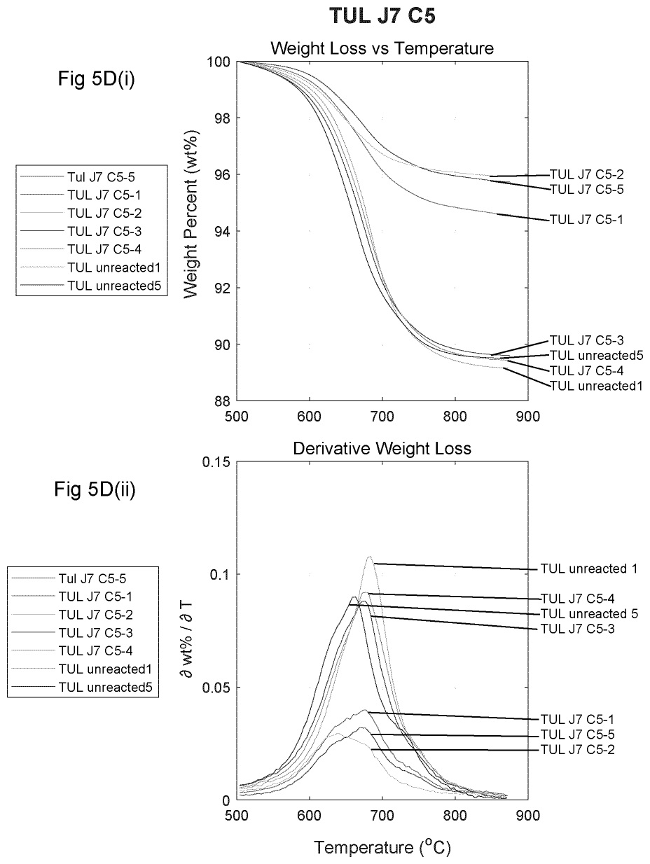

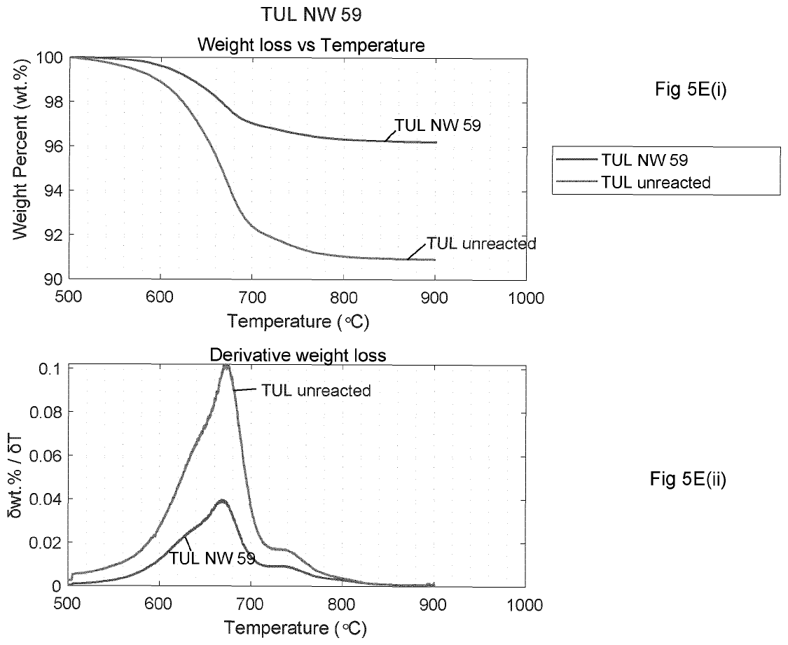

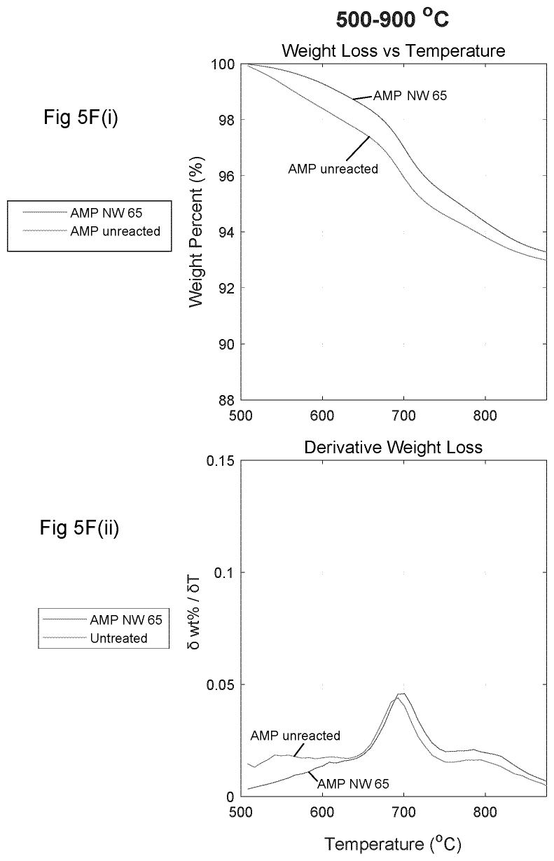

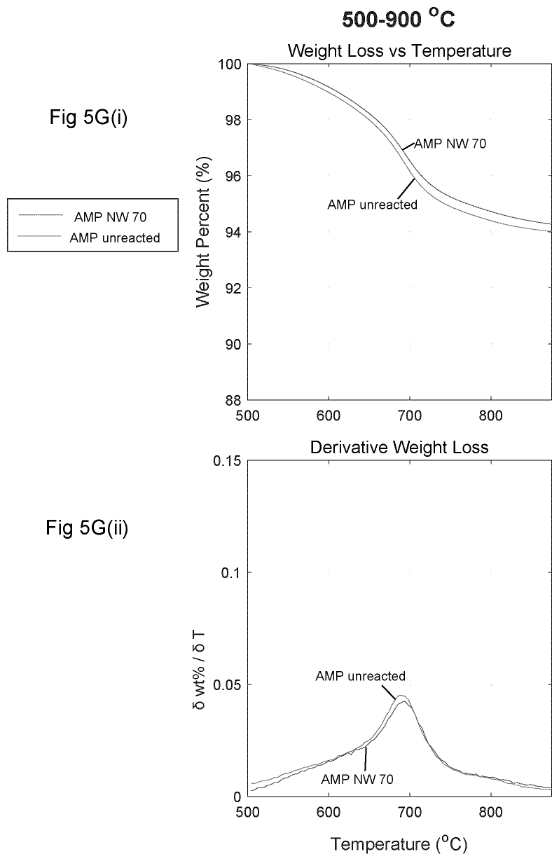

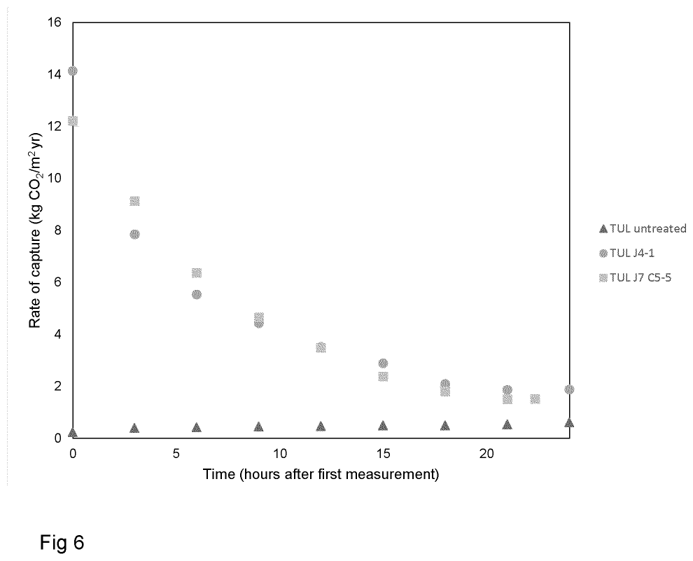

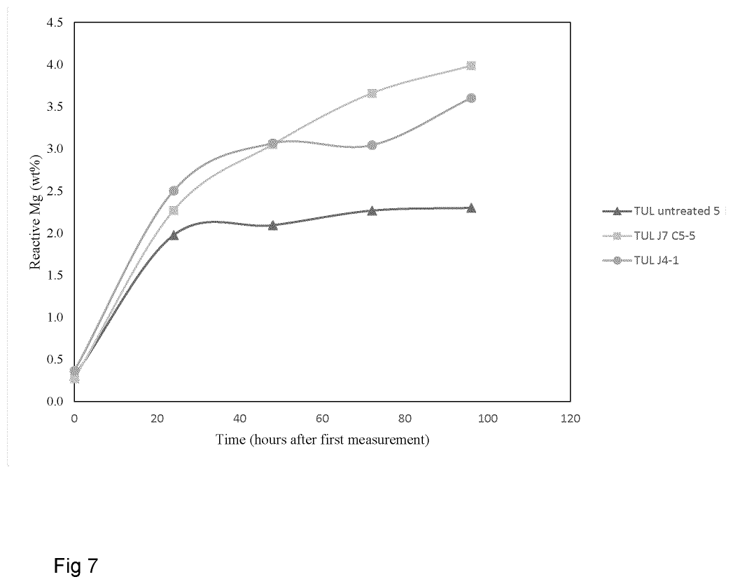

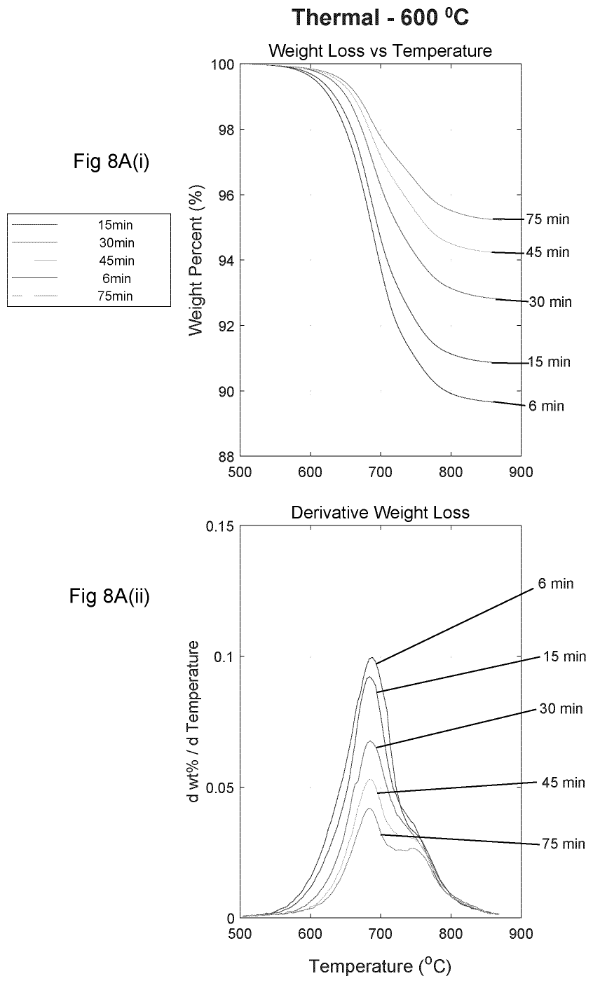

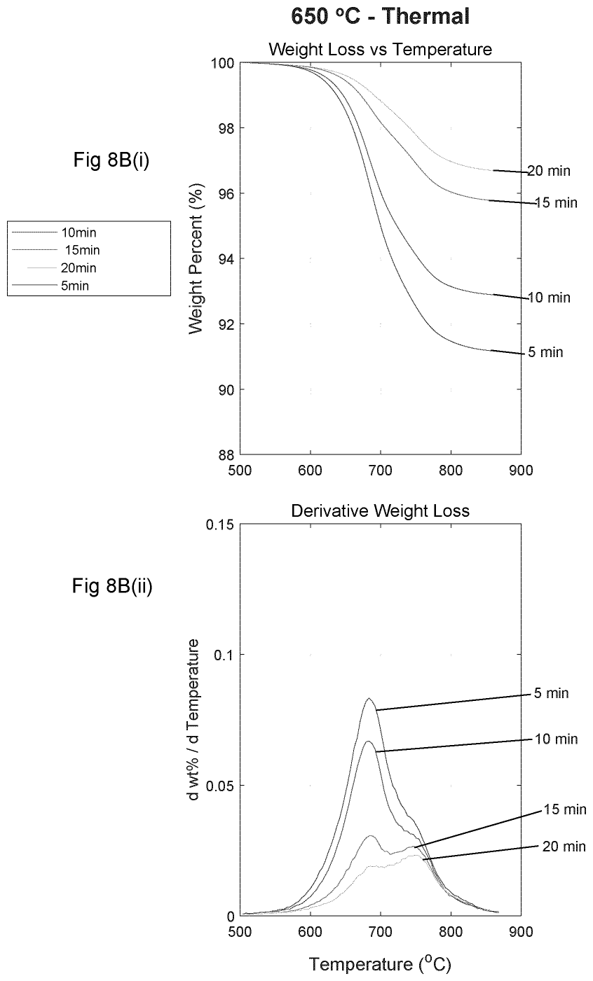

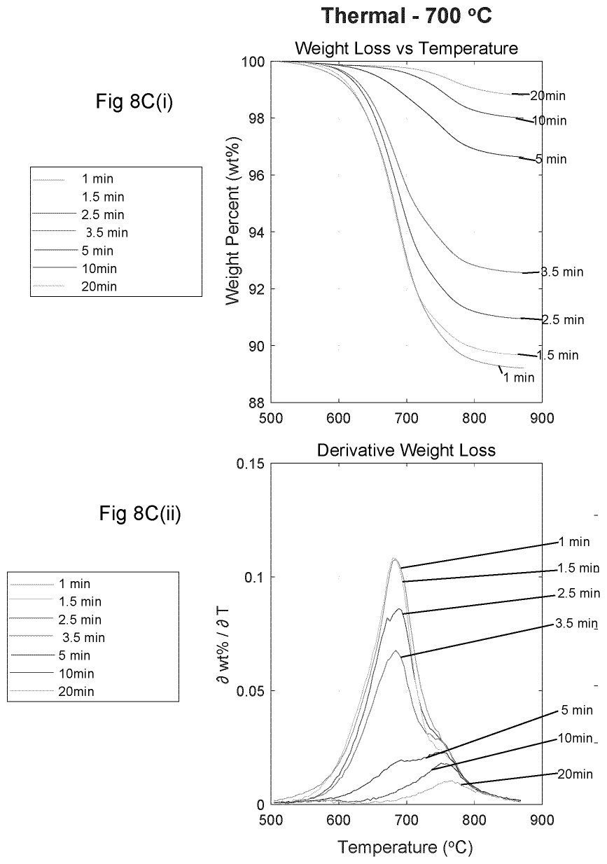

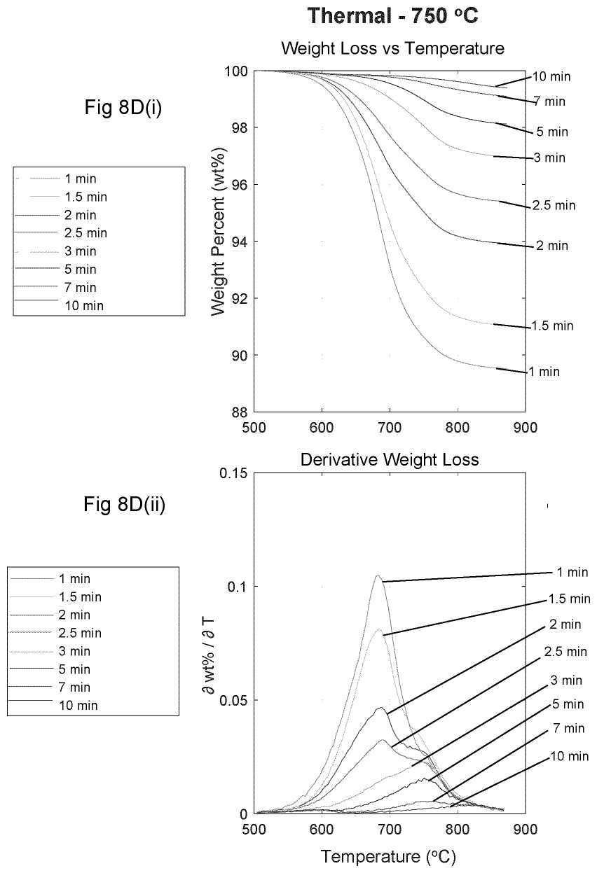

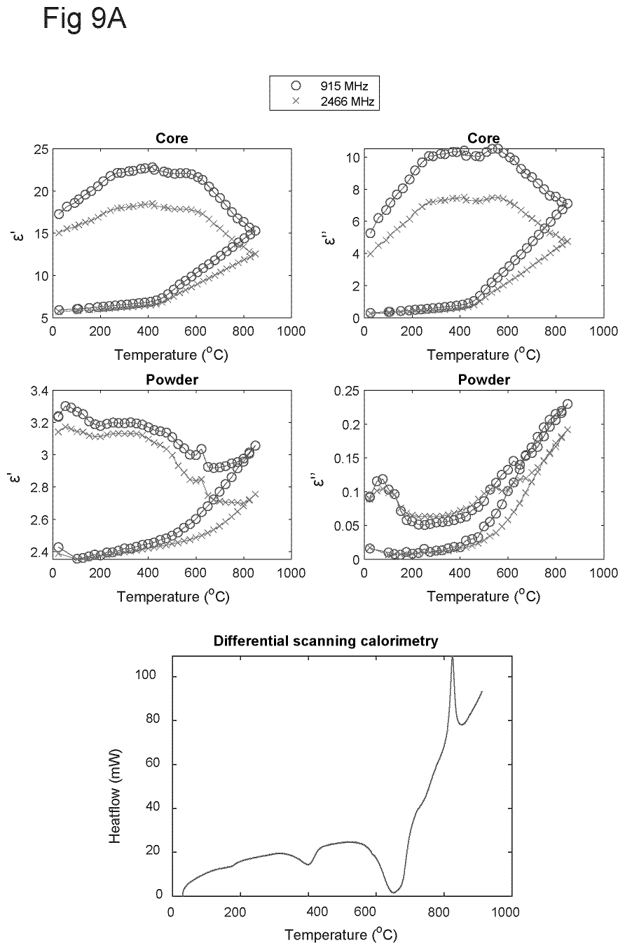

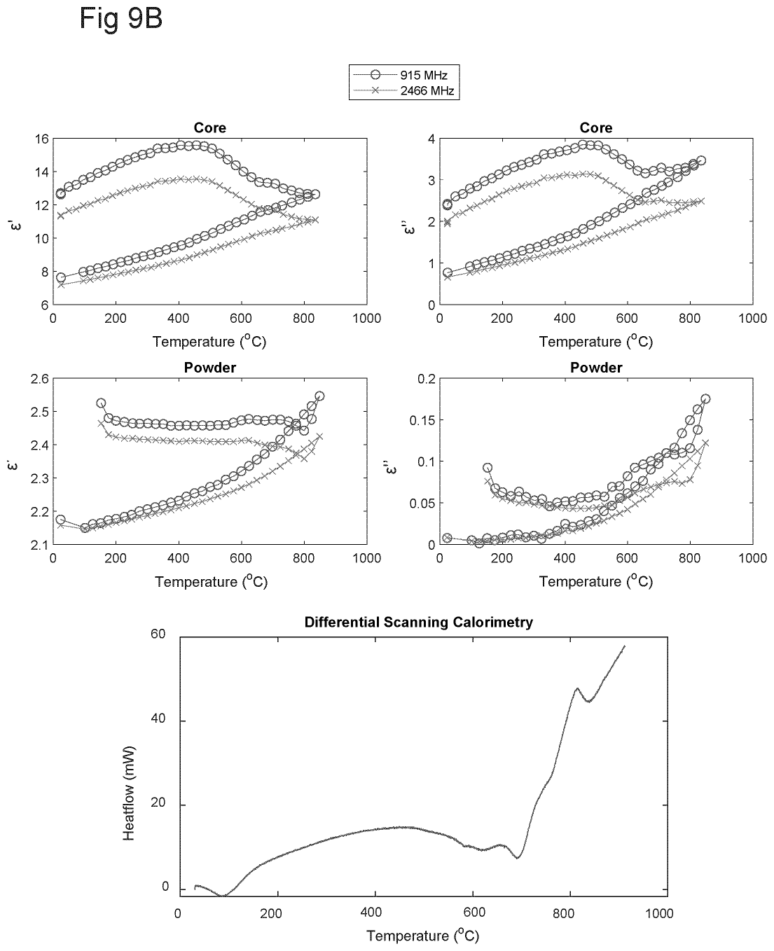

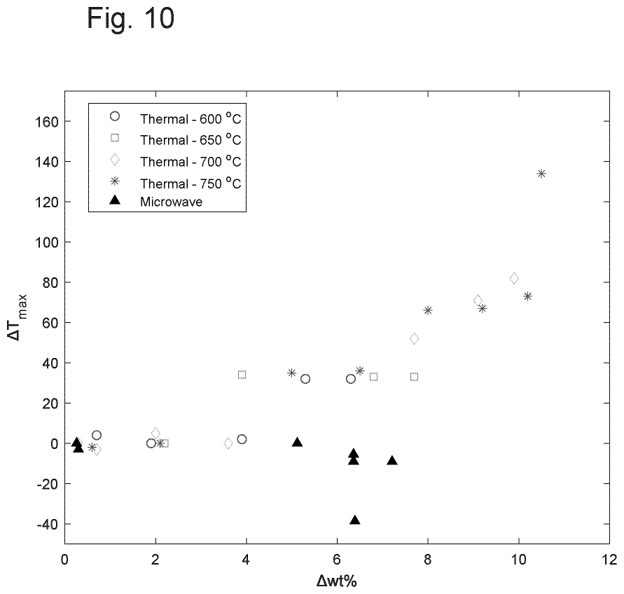

The thermal images captured after microwave exposure are shown in FIGS. 4A-4E. Surface temperatures of ATL 1 shows three distinct zones (near both ends of the slab and in the center) of temperatures between 300-450° C. Temperatures outside these three zones range between 60-300° C.

Comparison of the experimental and numerical surface temperatures and HOME values for ATL 1 shows good agreement in both distribution and magnitude of temperature. The model shows three distinct zones on the surface with temperatures between 300-462° C. The location of these three zones align with those in the thermal image. HOME, as measured experimentally (51.6%) and calculated (51.9%), are in very good agreement (FIG. 4A). The strong agreement between experimental and numerical results for ATL 1 demonstrates the accuracy with which numerical models can simulate the microwave experiments.

Surface temperatures of TUL J1 are all in excess of 300° C. and the center of the slab reached surface temperatures greater than 565° C. Surface temperatures for TUL J4 are similar to TUL J1; there is a zone in the center of the sample in which temperatures exceed 565° C. Across the remainder of the TUL J4 sample, temperatures ranged from 300-540° C.

Numerical simulations of the TUL J1 sample yields HOME values (24.7%) that agree with those measured experimentally (36.5%, FIG. 4B). Given the good agreement in experimental vs. calculated HOME, the inventors use the numerical simulations to determine the temperatures achieved during the TUL J1 and TUL J4 microwave experiments.

The numerical simulation indicates that at the end of the TUL J1 experiment the average temperature in the hottest portion of the rock was 580° C. and the average surface temperature was 395° C. Both values are consistent with the thermal image taken after the experiment (FIG. 4B) At the end of the TUL J4 experiment, the average temperature in the hottest portion of the rock was 617° C. and the average surface temperature was 466° C. (FIG. 4C).

For the crushed sample TUL J7 C3, there are two zones in excess of 565° C. that lie just to the left and right of the center of the sample (FIG. 4D). In between these zones, the temperature ranges between 280-490° C. Temperatures below 280° C. exist around the edge of the pile of material. Sample TUL J7 C5 displays two zones that have temperatures in excess of 565° C. (FIG. 4E). These zones are in the bottom left of the sample and just above the center of the sample. The remainder of TUL J7 C5 shows a range of temperature between 300-540° C.; the hotter portions generally being closer to the center of the sample.

Given that TUL J7 C3 and TUL J7 C5 have the same physical, thermal and dielectric properties as TUL J1 and TUL J4 (all are subsamples of a larger single sample), similar maximum temperatures for TUL J7 C3 and TUL J7 C5, 617° C., are inferred. Well defined sample dimensions and geometry are required for numerical simulations. Because both of these parameters are extremely difficult to quantify in the crushed samples, numerical simulations were not attempted for these samples.

Visual inspection of TUL J7 C3 and TUL J7 C5, after cooling, revealed a change in color for those areas of the samples that reached the highest surface temperatures. The color changes from black to reddish brown. Portions of samples with the largest color change also show the largest mass loss due to dehydroxylation of serpentine.

TABLE 1
Conditions of microwave experiments run in system 1

| | | | | | Total |
|---|---|---|---|---|---|
| | | | | | microwave |
| | | | Microwave | Exposure | energy |
| | | Weight | Power | Duration | applied |
| Sample | Type | (g) | (kW) | (seconds)* | (kWh/t rock) |
| ATL 1 | Slab | 298 | 15 | 7.2 | 100.0 |
| TUL J1 | Slab | 932 | 3 | 335.3 | 299.8 |
| TUL J4 | Slab | 525 | 5 | 116.0 | 306.9 |
| TUL J7 C3 | Crushed | 120 | 5 | 38.7 | 447.5 |
| TUL J7 C5 | Crushed | 480 | 5 | 108.7 | 314.4 |

*Time at maximum power, excludes ramp up time of 1.335 seconds

TABLE 2
Calorimetry results from system 1

| | Initial | Final | Mass | Microwave | |
|---|---|---|---|---|---|
| | water | water | of | energy | |
| | temperature | temperature | water | absorbed | HOME |
| Sample | (° C.) | (° C.) | (g) | (kWh/t rock) | (%) |
| ATL 1 | 18.2 | 26.9 | 1000 | 53.57 | 53.6 |
| TUL J1 | 12.2 | 85.4 | 1200 | 109.4 | 36.5 |
| TUL J7 C3 | 11.2 | 23.9 | 800 | 98.3 | 22.0 |

TABLE 3
conditions of microwave experiments in system 2

| | | | | | Maximum | Maximum |
|---|---|---|---|---|---|---|
| | | | Microwave | Exposure | surface | temperature |
| | | Weight | Power | Duration | temperature | at depth |
| Sample | Type | (g) | (kW) | (seconds) | (° C.) | (° C.) |
| TUL NW 59 | Powder | 1098 | 10 | 900 | 578 | — |
| AMP NW 65 | Powder | 1044 | 50 | 555 | 470 | 506 |
| AMP NW 70 | Powder | 1520 | 25 | 1260 | 450 | 497 |

1.-44. (canceled)

45. A method of enhancing the reactivity of a sample of a mineral to carbon dioxide comprising exposing the sample to microwave treatment for a treatment period to produce a microwave-activated mineral, wherein a bulk temperature of the sample does not exceed about 650° C. during the microwave treatment.

46. A method of reducing a temperature required to dehydroxylate magnesium-iron phyllosilicate minerals as compared to thermal treatment at the same heating rate and sample particle size comprising exposing a sample of the mineral to microwave treatment for a treatment period to produce a microwave-activated mineral, wherein a bulk temperature of the sample does not exceed about 650° C. during the microwave treatment.

47. The method as defined in claim 46, wherein the method reduces a temperature required to dehydroxylate powders of the magnesium-iron phyllosilicate minerals having a diameter of less than 250 μm to below 515° C.

48. The method as defined in claim 45, wherein the microwaves used to conduct the microwave treatment have a frequency of between about 300 MHz and about 300 GHz, optionally wherein the microwaves used to conduct the microwave treatment have a power of between about 1 and about 10 kW, optionally wherein the microwaves used to conduct the microwave treatment have a power of between about 10 and about 100 kW.

49. The method as defined in claim 45, wherein an applied power density of the microwaves is greater than about 10⁶ W/m³.

50. The method as defined in claim 45, wherein an applied power density of the microwaves is between about 10⁶ W/m³ to about 10⁸ W/m³.

51. The method as defined in claim 45, wherein the treatment period comprises between 0.1 second and 3.5 minutes, optionally wherein the treatment period comprises between 3.5 and 15 minutes, optionally wherein the treatment period comprises between 15 and 25 minutes.

52. The method as defined in claim 45, wherein the treatment period comprises between 0.1 seconds/kg of sample present and 20 minutes/kg of sample present.

53. The method as defined in claim 45, wherein a heating rate of the sample during the microwave treatment is greater than or about 100° C./min, optionally wherein a heating rate of the sample during the microwave treatment is greater than or about 150° C./min.

54. The method as defined in claim 45, wherein the sample comprises powdered rock, rock granules or rock fragments, wherein the powdered rock has an average particle diameter of between about 10 microns and about 250 microns, wherein the rock granules have an average particle diameter of between about 250 microns and about 1 mm, and/or wherein the rock fragments have an average particle diameter of between about 1 cm and about 25 cm.

55. The method as defined in claim 45, wherein the mineral comprises a mineral in the serpentine subgroup.

56. The method as defined in claim 55, wherein the mineral comprises antigorite, lizardite or chrysotile, optionally wherein the mineral comprises talc or a mineral in the chlorite subgroup, optionally wherein the mineral comprises chlinochore, chamosite, or odinite, optionally wherein the mineral comprises serpentine.

57. The method as defined in claim 45, wherein the mineral is serpentine and less than 20% of the serpentine is converted to olivine during the microwave treatment.

58. The method as defined in claim 45, wherein the sample does not contain magnetite.

59. The method as defined in claim 45, wherein a bulk temperature of the sample does not exceed about 600° C. during the microwave treatment.

60. The method as defined in claim 45, comprising exposing the sample to thermomechanical activation prior to the step of exposing the sample to microwave treatment.

61. The method as defined in claim 45, wherein naturally occurring electromagnetic susceptors are removed from the sample prior to microwave activation, wherein the naturally occurring electromagnetic susceptors comprise magnetite, pyrrhotite, and/or pyrite.

62. The method as defined in claim 45, wherein the total energy absorbed by the sample from the microwaves is between about 50 and about 300 kWh per tonne of the sample.

63. The method as defined in claim 45, wherein the microwave treatment selectively removes hydroxyl groups from the sample, wherein the total energy absorbed by the sample from the microwaves is less than or equal to about 225 kWh per tonne of the sample, and the microwave-activated mineral has at least about 4.75 weight % loss, due to dehydroxylation of the mineral, relative to a starting weight of the sample.

64. The method as defined in claim 45, further comprising exposing the microwave-activated mineral to carbon dioxide, optionally wherein the step of exposing the microwave-activated mineral to carbon dioxide comprises exposing the microwave treated mineral to atmospheric air at ambient temperature and ambient pressure, optionally wherein the microwave activated materials achieve a rate of capture from atmospheric air above about 2 kg CO₂/m² yr.
